(19) United States
(12) Patent Application Publication
(10) Pub. No.: US 2003/0231749 A1
(43) Pub. Date: Dec. 18, 2003

(54) Method and system for customized local call processing features and custom dial tones

(76) Inventors: Carol Ansley, Atlanta, GA (US); Mark Bugajski, Norcross, GA (US); Wade Carter, Snellville, GA (US)

Correspondence Address: ARRIS INTERNATIONAL, INC, 11450 TECHNOLOGY CIRCLE, DULUTH, GA, 30097, US

(21) Appl. No.: 10/461,764

(22) Filed: Jun. 13, 2003

Related U.S. Application Data
(60) Provisional application No. 60/388,504, filed on Jun. 13, 2002.

(51) Int. Cl. H04M 11/00

(52) U.S. Cl. 379/93.17

(57) ABSTRACT

A user interface accesses a storage device and allows a user to change telephony features in a system that provides telephony service over IP. A user logs in to an MTA of a telephony terminal and chooses which features to change and which options associated with the chosen feature(s) is to be selected. The features may apply to incoming call features, such as ring cadence, and outgoing features, such as call blocking.

A service provider may substitute an audio or video message or file that plays while a telephone is off hook until a call is completed, which occurs when the party being called places their respective telephone off hook. The message being played could be an advertisement that is played automatically based on the time of day, the telephony service subscriber accepting such advertising in exchange for reduced telephone service rates.

### CROSS REFERENCE TO RELATED APPLICATION

This application claims the benefit of priority under 35 U.S.C. 119(e) to the filing date of Ansley, et al., U.S. provisional patent application No. 60/388,504 entitled “Method and System for Customized Local Call Processing Features and Custom Dial Tones”, which was filed Jun. 13, 2002, and is incorporated herein by reference in its entirety.

### FIELD OF THE INVENTION

The present invention generally relates to providing telephony over Internet protocol, and, more particularly to facilitating user-selectable telephony features.

### BACKGROUND

As the use of digital data for transporting communications signals continues to grow in the consumer sector, more and more homes and offices are beginning to receive telephony services using an Internet connection. Furthermore, the physical network that transports the data may comprise a community antenna television (“CATV”) coaxial cable (“coax”) network. In such a scenario, a drop from a service provider's outdoor coaxial cable plant connects to subscriber premise equipment (“SPE”), which is sometimes located outside a home or small office, or inside the premises. Within the SPE, television video signals and data signals, such as for example, Internet signals, are broken out and routed to their corresponding equipment. A cable modem is an example of an SPE with a coaxial cable connection for interfacing with a CATV network and typically an Ethernet or USB connection for providing the data signal. To the cable modem, a media terminal adapter (“MTA”) is typically connected if a customer receives telephony services via the data signal. In addition, some manufacturers house the cable modem and MTA as a single device, for example, a Touchstone™ Telephony Modem product (“TTM”), as offered by ARRIS International, Inc.

A TTM provides a user with telephony services over an Internet Protocol data network, which may utilize a cable modem termination system (“CMTS”). Cable telephony generally, the technology of which is known in the art, provides a subscriber with telephony service that is transparent as to the source of the service. In other words, a user plugs a telephone into a TTM and can access a set of features such as, for example, dial tone, call waiting and other features similar to those provided by a traditional plain old telephone system (“POTS”). Although the performance of the TTM in providing standard POTS services is satisfactory to most users, standard POTS does not allow a user to easily or inexpensively manipulate the feature set.

For example, a standard feature set includes a standard dial tone frequency heard by the user indicating the existence of telephony service availability. Generally, every user that uses a telephone is familiar with the same dial tone. In addition, typical residential POTS has a generic ring cadence, however, this precise cadence may vary from region-to-region, based on the equipment and settings thereof of and by the various telephony service providers. Also, loudness of the dial tone and audio from the receiver while the phone set is in operation are typically similar from telephone system to telephone system.

However, some telephone systems may be configurable with respect to some of the features with which a user interfaces. For example, some users may be hard of hearing and would appreciate having a louder audio signal when using a telephone receiver. In addition, some individuals may have hearing loss at specific frequencies that coincide with the standard telephony dial tone, which typically comprises a combination of a 350 hertz tone and a 440 hertz tone. Thus, these individuals may appreciate being able to adjust the dial tone frequency or frequencies so that they can more readily determine that telephony service is available when they attempt to use a telephone.

Furthermore, some users may wish to change the cadence with which the telephone receiver indicates that an incoming call is being attempted from another telephone. Moreover, a user may wish not only to modify the ring cadence, but to modify the cadence to be different for calls coming from different telephone numbers. For instance, if a parent wants to know when a child is calling, the ring cadence could be adjusted to ring with a first cadence. If a parent-in-law is calling, the user may appreciate the ability to associate a different second ring cadence with a call placed by the parent-in-law. Alternative, if a user subscribes to two different telephone numbers, the user may wish to assign a different ring cadence to one than to the other.

Although some of these features may be customized using current technology, the technology generally requires that either the telephone equipment be configured by a technician when the telephone sets/lines are installed or subscribed to, or a service provider may have to configure some of these features from a central office (“CO”). This typically adds costs to a given installation/product due to the man-hours required to customize and change the features. Furthermore, it is inconvenient for a user to have to contact a service provider to make changes in any features that may be configurable. In addition, such changes may incur a fee from the provider.

Therefore, there is a need in the art for a method and system for providing for the convenient and inexpensive customizing of certain features with which a user typically interfaces.

### SUMMARY

A method allows a subscriber to and user of telephony services and equipment to conveniently configure features of said telephony services and with which they interface. A user interface can be connected electrically to an MTA, which processes data received from a cable modem, and converts it into signals suitable for further processing by subscriber line interface card (“SLIC”) circuitry. Since the signal received by the cable modem contains digital data, the information contained therein can be easily manipulated by the MTA to provide user selectable features, without having an impact on the rest of the data network, such as, for example, the Internet. Thus, a feature set comprising at least one, and typically more than one, optional setting for each of at least one predetermined feature, or features, can be accessed and/or changed with common user interface devices. Such devices may include, but are not limited to a computer, a PDA, a wireless device, or a telephone keypad that is part of the telephone for which the features will apply.

### BRIEF DESCRIPTION OF THE DRAWINGS

FIG. 1 illustrates a system for facilitating user-changeable features in telephony-over-IP device.

FIG. 2 illustrates a flow diagram for implementing user-changeable features in telephony-over-IP device.

FIG. 3 illustrates a system for streaming audio content/programming as a substitute for a standard telephony dial tone.

FIG. 4 illustrates a system for downloading audio content/programming from a head end to a SPE for a standard telephony dial tone.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude other embodiments, adaptations, variations, modifications and equivalent arrangements, the present invention being limited only by the claims appended hereto and the equivalents thereof.

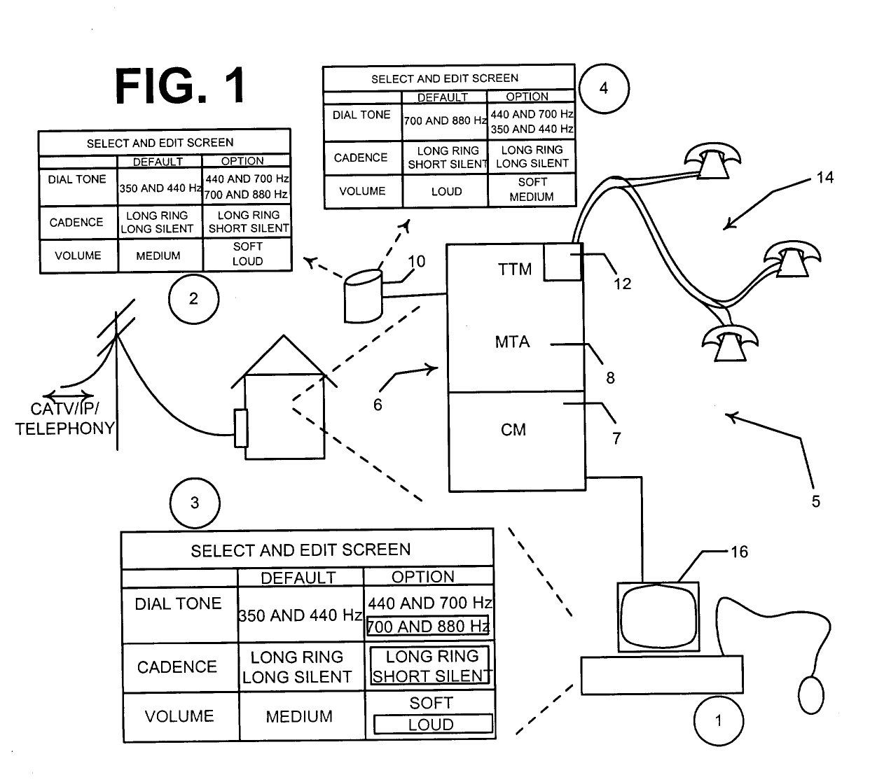

Turning now to the Figures, FIG. 1 illustrates a system 5 for implementing user-changeable features in telephony-over-IP device 6. Device 6, an example of which is a TOUCHSTONE TELEPHONY MODEM™ (“TTM”) provided by ARRIS™ International, Inc., typically includes a cable modem section 7 and a media terminal adapter section 8.

To facilitate customizing various features, a flash memory 10 stores data that correlates a particular feature with the instructions used by MTA 8 to drive a subscriber line interface card section (“SLIC”) 12. For example, if MTA 8 is programmed so that when an incoming call is received, telephones 14 will ring with a long ring and with an equivalently long silence interposed between rings, the corresponding instruction will be loaded into operating memory, typically RAM, when TTM 6 boots-up. Thus, when an incoming call is received, the instruction loaded from flash 10 will be used by MTA 8 to provide an instruction signal to SLIC 12, causing it to ring for a long period followed by an equally long silence between rings.

If a user/subscriber wishes to change the preferences for ring cadence, for example, the user would access a user interface device 16, such as, for example a personal computer (“PC”). It will be appreciated that other user interface devices may also include a personal digital assistant (“PDA”), a wireless device, or other interface devices known in the art. The keypad of any of telephones 14 could also be used to access the flash memory 10 and enter changes thereto.

To begin the access process, the user logs into the interface device 16 at step 1, typically by entering a password and login name. TTM 6 compares the login information to data stored in flash 10. If the login information entered matches the stored data, TTM 6 authenticates the user attempting to make changes and accesses the preference information stored in flash 10 at step 2. This preference information is displayed on the user interface device 16 as shown at step 3, thereby providing the user with a visual snapshot of the currently selected preferences. It will be appreciated that, depending on the type of interface 16 being used, there may not be a visual display. For example, if one of telephones 14 are used to access flash 10, the data could be provided via a audio menu system, examples of which are familiar with many individuals who have interacted via telephone with various service providers in the modern world.

Regardless of the type of interface 16 used, after the user has been apprised of the currently selected feature set, or preferences, the user may then select from available features, other than the ones currently selected. These optional features are also displayed, or conveyed audibly, depending on the type of interface 16 being used, when the currently selected feature set is provided. For example, as shown in the Figure, the display of the contents of flash 10 at step 2 indicates that the dial tone frequency is 350 Hz and 440 Hz, a standard telephony dial tone. The options are either 440 Hz and 700 Hz, or 700 Hz and 880 Hz. A particular user may select one or the other of these optional dial tones if one sounds more pleasing to the user or, if one is more easily distinguishable that either the other optional dial tone or the currently selected dial tone.

Other selectable features shown in the drawing include cadence and volume. As discussed above, the standard ring cadence may be long rings with equally long silences interposed between rings. As shown in the example, the user may select a long ring with short periods of silence interposed between the rings. Similarly, the standard audio volume may be set for a medium level, with either loud or soft being optional setting that may be selected.

Accordingly, the currently selected feature set, as stored in flash 10 is displayed, or otherwise made available to a user, by user interface 16 at step 3. After reviewing the currently selected feature set, the user may then select to change some or all of the selectable features in the feature set. Upon making any changes, the updated feature set preferences are stored to flash at step 4, and this updated feature set is also loaded into RAM. To load the RAM properly, the TTM may be re-booted. As shown by the example illustrated in the figure, the user selected 700 Hz and 880 Hz for the preferred dial tone, long rings with short silences interposed there between and loud audio levels. Thus, when any of telephones 14 are connected to SLIC 12, they will operate with the feature set selected and stored at step 4.

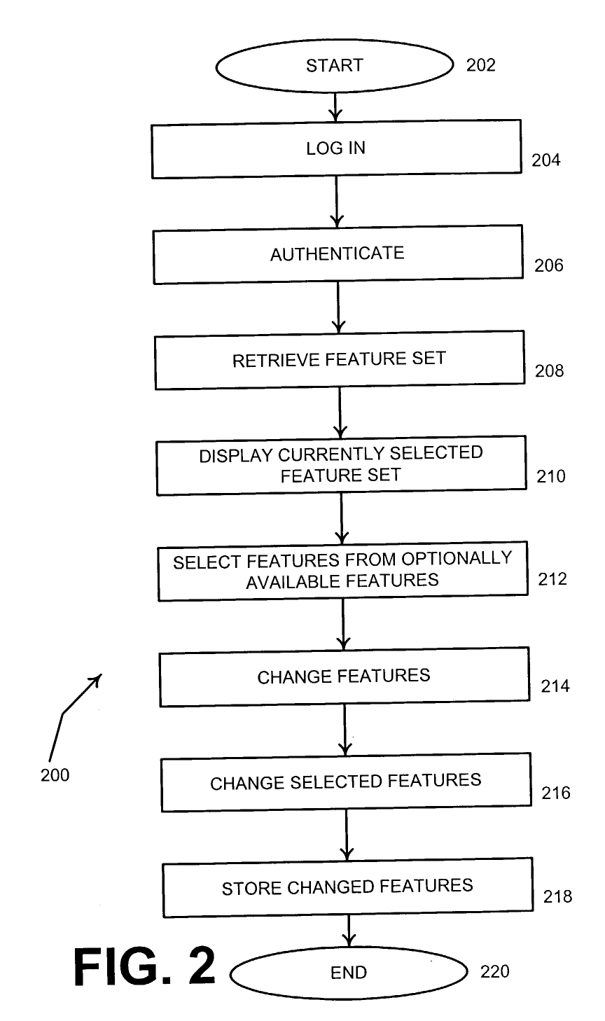

Turning now to FIG. 2, a method 200 for customizing a feature set in a voice over IP system is shown. After beginning the process at step 202, a user logs in at step 204 by entering login information, typically including a username and password, into a user interface device such as, for example, a PC, a PDA or a telephone keypad, for example. Upon receiving the login information, a IP telephony device, such as, for example, a TTM, authenticates the user based on the entered login information at step 206. Upon authentication, the TTM retrieves a currently stored feature set from its flash memory at step 208 and displays (or otherwise makes available by audio, for example) said information on the user interface device at step 210. Now, the user can review the currently selected features as well as optionally available features.

For example, the user can observe the currently selected ring cadence is long rings with long silent periods in between. The optionally available features for ring cadence may include long rings with short periods of silence in between, or short ring tones with long silent periods, or short rings with short silence periods in between. It will be appreciated that this is not a comprehensive listing of all of the potential cadence options. It will also be appreciated that the listings of optionally available features corresponding to other feature parameters, such as, for example, audio volume, dial tone, are also not comprehensive of all options that may be available. Furthermore, it will also be appreciated that the listing of feature parameters, such as audio volume, cadence and dial tone is not a comprehensive listing of all of the parameters that may be customizable. The listings of feature parameters and optionally available features corresponding to each of these parameters is provided herein as examples that illustrate features of which change from time to time may be commonly desired.

Following the displaying, or otherwise providing, of the currently selected features and the optionally available features to the logged-in user, the user determines which, if any, features they would like to change at step 212 and then the changes are made by entering the changes with an interface device, such as, for example, a mouse, a keyboard, a keypad, a touch-screen, a stylus, or other input device known in the art, at step 214. Upon entering the desired changes at step 214, the TTM stores the updated features to an updated feature set at step 216 before the method ends at step 218.

In addition to the feature parameters already described, others may include fast dialing by assigning predetermined telephone numbers to a hotkey, or sequence of keys. For example, one's parent's telephone number could be programmed such that it is dialed when a user presses #1 and one's child's telephone number could be programmed as #2. In conjunction with voice recognition software, the feature set could be programmed to dial a parent or child based on learned names associated with the corresponding telephone number, the voice recognition name being associated with the appropriated telephone number stored in the flash memory. Also, intercommunication between multiple lines and other ‘soft’ public branch exchange features may be facilitated.

In addition to the ability to tailor a ringing cadence with a particular incoming call based on caller ID information, call blocking based on caller ID information may also be implemented by storing preferences to the features set in flash. This could facilitate blocking certain incoming and outgoing calls from and to certain predetermined area codes and telephone numbers, and even further tailor the blocking with respect to time of day.

Other customizable features may include password security information, selection of a call forwarding number and automatic call routing so that an incoming call follows a subscriber user to a cell phone, a hotel room number or a host's telephone number when the user is away from home. In addition, telephone numbers can be linked to e-mail addresses or URLs, e.g. VAR menus, so that a user can reply to a call via e-mail or an advertiser can attach a URL so that a user may access its web page for further information about goods or services discussed in a telephone call. These features could also be used to block calls from merchants or individuals whose e-mail addresses are known, but their telephone number is not, or their caller ID information is suppressed. In general, it will be appreciated that features associated with outgoing, as well as incoming calls, can be customized/managed. In addition, it will be appreciated that storage of the customized/managed features may be stored locally in flash at the MTA, or may be stored remotely at a service providers server location, typically at a head end facility.

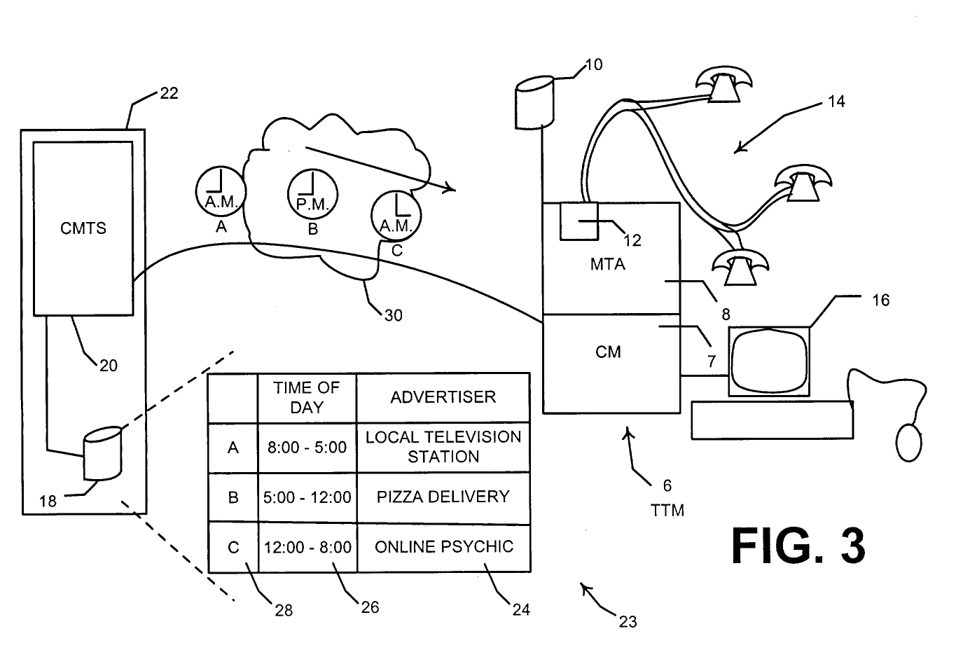

As shown in FIG. 3, this may be accomplished by facilitating having a user provide login information via the Internet. Alternatively, this may be accomplished by the service provider providing/changing/managing features at its discretion.

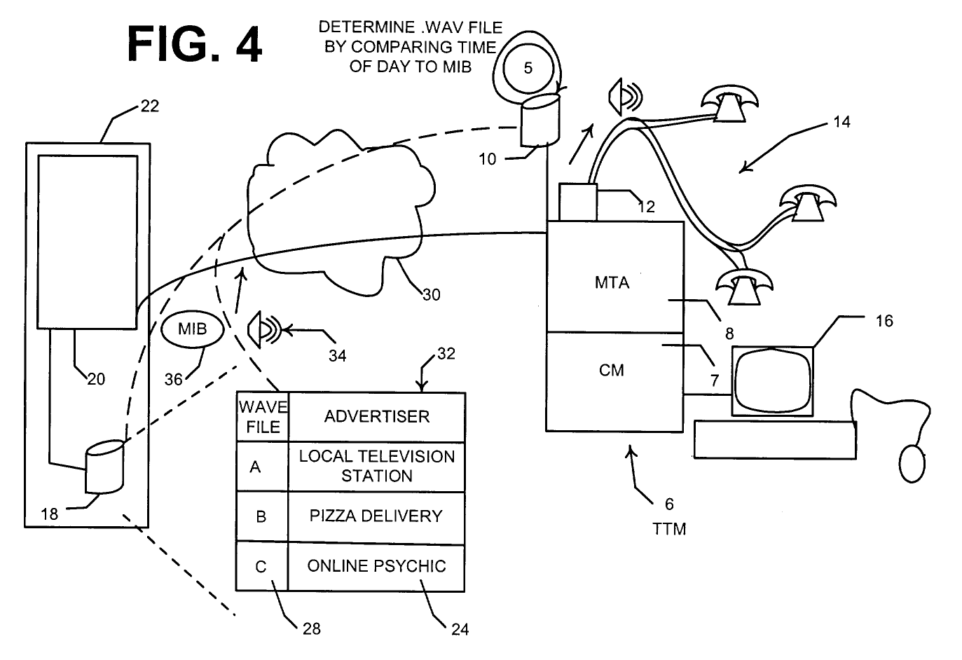

For example, in exchange for low-, or no-cost telephony service, a subscriber may be willing to allow a service provider to customize the call progress signals, such as, for example, dial tone, ring indication or busy signal, to play a audio or video message, such as, for example, an advertisement for a pizza delivery restaurant on a Friday evening between the hours of 5:00 P.M and 11:00 P.M. The advertisement could be streamed from the service provider's server 18 connected to CMTS 20 at head end 22. In the example shown, a message for each of three different advertisers may be stored in matrix 23. Each message 24 corresponds to a particular range 26 of time of day and to a particular reference code 28. When a user places one of the plurality of telephones 14 off hook, equipment at the head end 22 detects the progress state of the user's telephone call (e.g. the user's telephone is off hook and a dial tone should be provided, a telephone number is being dialed or the telephone at the other end is ringing) and server 18 determines the appropriate code 28 to play based on comparing the current time of day to the time ranges 26. The message 24, typically a WAV file, corresponding to the appropriate code 28 is provided to CMTS 20 for downstream transmission to the users TTM 6 via CATV network 30. Thus, if a user attempts to place a call using one of telephones 14 at 9:00 A.M, a .wav file (a WAV or .wav files being known in the art), which in the example contains an audio advertisement for a local television station, may be sent via real-time streaming technology, also known in the art, to TTM 6, where cable modem 7 receives and decodes the incoming RF signal and provides to MTA 8, which in turn provides through SLIC 12 to telephone 14. It will be appreciated that any data capable of being transmitted via streaming technology may be used, including a streaming signal from an actual live radio or television broadcast. When the advertisement is streamed from head end 22 to TTM 6, it will be appreciated that storage of the streamed information may not have to be stored in flash memory 10, although doing so may be desirable so that the MTA can use an MIB stored therein to decide which file to play based on the time of day. This aspect will be discussed in detail in reference to FIG. 4.

Still referring to FIG. 3, it will be appreciated that if a user attempts to place a call at 9:00 P.M., a message advertising a pizza delivery company may be delivered instead of a standard dial tone. Likewise, if a call is placed at 3:00 A.M., a message for an online psychic may be streamed in place of the standard dial tone. Naturally, in such a system, if a service provider so chooses, a standard dial tone, or any other audio or video data may be played via the streaming mechanism. Thus, software, hardware and firmware resources are not heavily burdened, as the information being substituted for a standard dial tone is being provided by the head end, rather than onboard. In addition to just providing one message, a provider may also choose to have a rotating sequence of messages that may or may not be stored in a single .wav file, or other similar audio content format. Thus, much as a commercial radio or television station does business, a provider can control the frequency with which a given advertiser's messages are played to subscribers based on the amount of time the advertiser has purchased. When the call is completed, (e.g., the telephone at the other end is placed off hook), the alternate message, which may be audio or video, stops playing and the telephone users converse as in a traditional telephony system.

Turning now to FIG. 4, a system for playing a .wav file, or other format audio file is illustrated where the audio file is downloaded from a provider's head end 22 over network 30 and stored in flash 10, or similar, memory within TTM 6. Message matrix 32, which may contain multiple advertisement messages may be compiled into a single .wav file 34 and transmitting to TTM 6, where the WAV file is stored in flash 10. In addition, a management information base (“MIB”) 36, known in the art, may be transmitted from head end 22 to TTM 6 as well. MIB 36 may contain an array of information that provides instructions to MTA 8 regarding which advertisement message to play. By comparing instructions contained in MIB 36, which may direct MTA 8 to play either message 28A, B, or C depending on the time of day, with the current time of day at step 5, the MTA can play the appropriate messages associated with the appropriate message code. As opposed to the streaming method described in reference to FIG. 3, playing a file directly from flash may result in higher quality audio and therefore may be desirable to an advertiser as well as service provider, as downstream bandwidth is not used when playing from the MTA. Thus, a service provider can choose a time of day (or most probably night) to download message 34 and MIB 36 when bandwidth usage is low relative to the peak usage hours during a typical day.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

We claim:

1. A method for user to customize features of a device for providing telephony service over a data network, comprising:
logging in to a media terminal adaptor;
providing authentication information to the media terminal adaptor;
displaying on the user interface a catalogue of features that may be customized;
selecting one or more features from the catalogue to be customized, each feature selected being in a current state;
changing at least one of the one or more features from its current state to a new state; and
storing the new state or states to a memory.

2. The method of claim 1 further comprising downloading an updated catalogue of features to be customized.

3. The method of claim 1 wherein the memory includes a flash memory device.

4. The method of claim 1 wherein a keypad is used for logging in to the MTA.

5. The method of claim 1 wherein a user interface device is used for logging into the MTA.

6. The method of claim 5 wherein the user interface includes a terminal device.

7. The method of claim 6 wherein the terminal device is a personal computer.

8. The method of claim 6 wherein the terminal device is a personal digital assistant.

9. A method for playing an alternate message instead of standard telephony audio call progress signals, comprising:
detecting the progress state of a user's telephone call; and
providing the message from a database before the call is completed.

10. The method of claim 9 wherein the database is located remotely at a service providers centralized location.

11. The method of claim 9 wherein the database is located locally at a users media terminal adapter.

12. The method of claim 9 wherein the message played is determined based on the time of day.

13. The method of claim 9 wherein the message is an audio message.

14. The method of claim 9 wherein the message is a video message.
